(19) United States
(12) Patent Application Publication
(10) Pub. No.: US 2007/0199959 A1
(43) Pub. Date: Aug. 30, 2007

(54) Closure with selectable dispensing orifices

(75) Inventor: Stephen B. Getsy, Pittsburgh, PA (US)

Correspondence Address: PEPE & HAZARD, LLP, 225 ASYLUM ST., HARTFORD, CT, 06103, US

(73) Assignee: Silgan Plastics Corporation

(21) Appl. No.: 11/363,631

(22) Filed: Feb. 28, 2006

(51) Int. Cl. B67D 3/00; B65D 35/00; B65D 51/18; B65D 47/00; B65D 35/38

(52) U.S. Cl. 222/480; 222/548; 222/556; 222/575; 222/107; 220/253

(57) ABSTRACT

A dispenser for dispensing a viscous material in a selected one of a multiplicity of configurations comprises a container for a volume of a viscous material and having a squeezable body and a neck with a discharge opening at its upper end. Engaged on the container is a closure body of generally circular cross section having a top wall and a skirt, and the top wall has a discharge passage therethrough aligned with the discharge opening of the neck. The body top wall has a generally circular recess therein extending from the periphery thereof and beyond the discharge passage of the closure. Disposed in the circular recess is a generally circular rotating disc which has a multiplicity of discharge openings spaced about the disc in a circular array, and the discharge openings have a multiplicity of configurations. The disc is rotatable to align a selected discharge opening with the discharge passage in the top wall to permit viscous material to flow through the neck and the top wall of the closure body into and through a selected disc discharge opening.

### BACKGROUND OF THE INVENTION

The present invention relates to containers and, more particularly, containers for dispensing viscous materials such as foodstuffs and decorative materials.

Dispensers for various types of viscous materials include tubes of frosting, sealant cartridges, toothpaste tubes and the like. In some instances, the dispensers have a fitment which provides both a large aperture and a small aperture for dispensing, either of which may be selected depending upon the volume to be dispensed.

Some food products employ packaging which allows children to dispense a food product by squeezing a compressible container containing a viscous comestible such as cheese, peanut butter, jelly and the like. The child is able to make patterns of the food product on a cracker or bread slice, thus providing some play action.

It is an object of the present invention to provide a novel squeezable container for a viscous product which can be discharged through a dispensing closure which provides a multiplicity of discharge openings of different cross section.

It is also an object to provide such a container which permits facile switching among the several discharge openings.

Another object is to provide such a squeezable container which may be readily assembled from easily fabricated components.

### SUMMARY OF THE INVENTION

It has now been found that the foregoing and related objects can be readily attained in a dispenser for dispensing a viscous material in a selected one of a multiplicity of configurations comprising a container for a volume of a viscous material and having a squeezable body and a neck with a discharge opening at its upper end. A closure body of generally circular cross section having a top wall and a skirt is engaged on the container, and the top wall has a discharge passage therethrough aligned with the discharge opening of the neck. The top wall has a generally circular recess therein extending from the periphery thereof and beyond the discharge passage of the closure body. Disposed in the circular recess is a generally circular rotatable disc having a multiplicity of flow openings spaced thereabout in a circular array. The flow openings provide a multiplicity of configurations and the disc is rotatable to align a selected flow opening with the discharge passage in the top wall. This permits viscous material to flow through the neck and top wall of the closure into and through a selected disc flow opening. The container neck is externally threaded and in the bottom surface of the closure body top wall has a depending threaded barrel portion which is threadably engaged with the neck.

Generally the container is a flexible tubular member sealed at the end opposite the neck. The closure also desirably, includes an overcap having a top wall and a peripheral skirt, and the lower surface of the top wall of the overcap includes a circular boss concentric therewith and bearing on the disc. The means for rotatably mounting the disc preferably comprises an aperture in the closure top wall and a mounting post on the disc which snaps into the aperture.

### BRIEF DESCRIPTION OF THE DRAWINGS

FIG. 1 is a perspective view of a container embodying the present invention with the overcap in an open position and with the tubular container fragmentarily illustrated;

FIG. 2 is a perspective view of the closure body with the disc and overcap removed;

FIG. 3 is a perspective view of the disc;

FIG. 4 is an elevational view of the closure in partial section with the overcap open;

FIG. 5 is an enlarged view in partial section of the portion of the closure bounded by the circle D in FIG. 4; and

FIG. 6 is a sectional view with the closure on the container.

### DETAILED DESCRIPTION OF THE PREFERRED EMBODIMENTS

Turning first to FIG. 1 of the attached drawings, therein illustrated is a dispenser embodying the present invention comprising a tubular container generally designated by the numeral 10 and a dispensing closure generally designated by the numeral 12. The closure 12 has a body generally designated by the numeral 14, a dispenser disc generally designated by the numeral 16, and an overcap generally designated by the numeral 18.

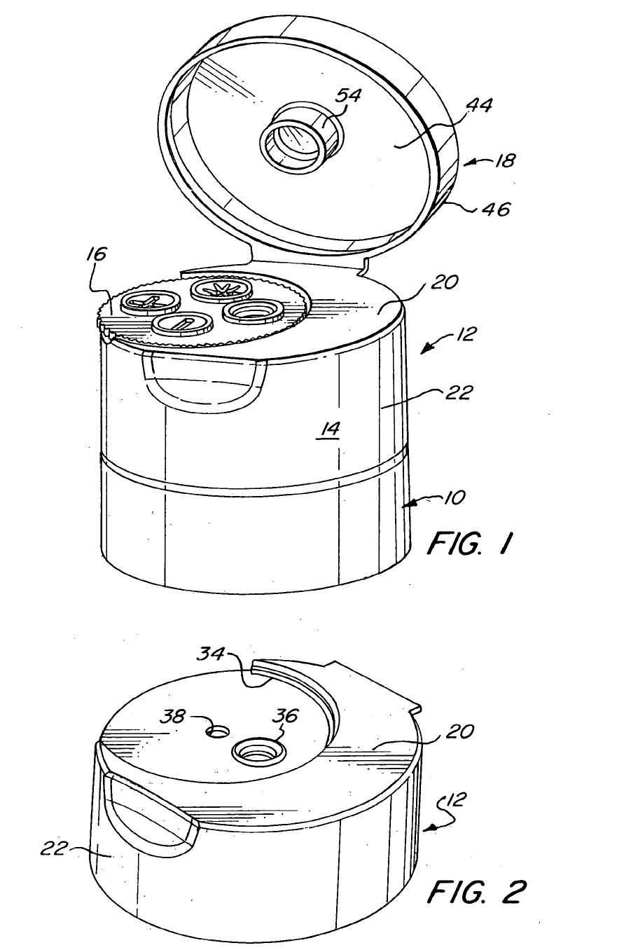

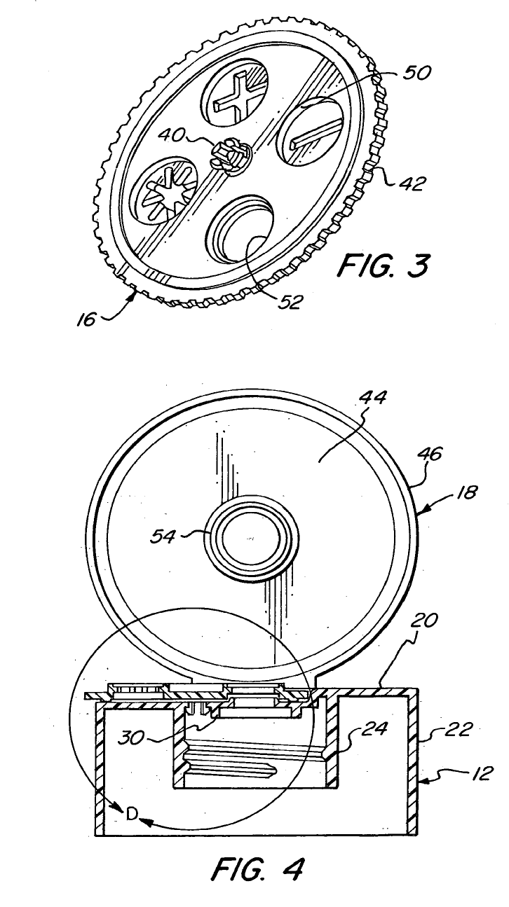

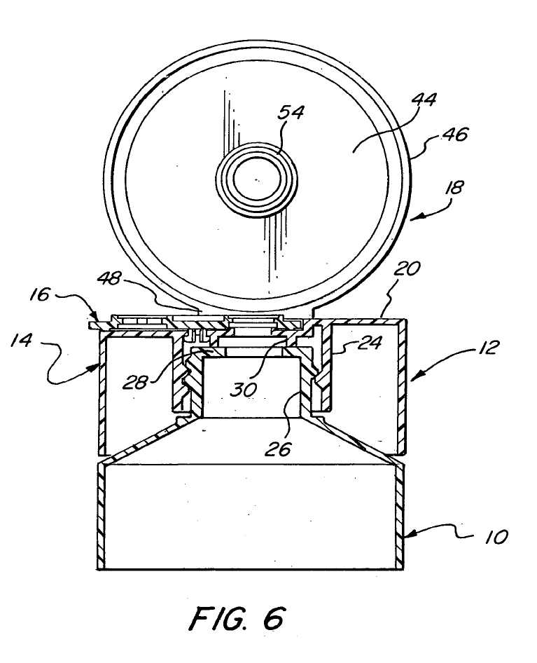

As seen in FIGS. 2-6, the closure body 14 has a top wall 20 and a peripheral depending skirt 22. A threaded barrel 24 depends from the lower surface of the top wall 20 and is threadably engaged with the neck 26 of the container 10, and the lip 28 of the container neck 26 bears against the annular ring 30 on the lower surface of the top wall 20.

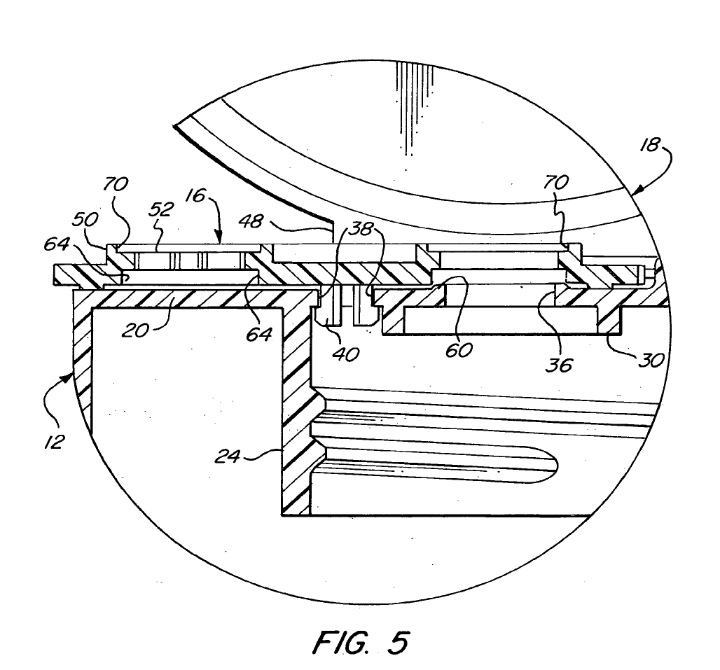

As seen in FIG. 2, the top wall 20 has a circular recess 34 which extends from the periphery thereof to beyond a central aperture 36 about which is a small ring 60 on the upper surface. As seen in FIG. 5, the top wall 20 has an aperture 38 offset from the barrel 24.

Turning now in detail to the disc 16, it is of circular configuration dimensioned to rotatably seat in the recess 34. At its center is a depending snap fastener 40 which is snap fit into the aperture 38 to provide rotatable engagement. The periphery of the disc 16 is provided with teeth 42 to facilitate its rotation. Spaced about the snap fastener 40 are four bosses 50 with discharge openings 52 of different configurations.

As best seen in FIG. 5, the top surface of the top wall 20 has an annular boss 60 around the central aperture 36 and the lower surface of the disc 16 has a recess 64 around each of the discharge openings 52 in which the annular boss 60 seats to provide a positive stop in the rotation of the disc.

The overcap 18 has a top wall 44 and a peripheral skirt 46. The closure is integrally molded with a living hinge 48, and a ring boss 54 bears upon the disc 16 in the closed position. The bosses 50 have a recess 70 about the upper end of the discharge openings 52 in which the ring boss 54 on the overcap 18 seats to reduce drying out of the product.

It will be readily appreciated that the squeezable container can take the form of a tube or a bottle, and it can be easily fabricated by extrusion and molding of tubular shapes, and injection and blow molding of synthetic resin to form bottles in accordance with general technology. The resin employed should allow facile squeezing to compress the container and force material to flow outwardly of the container. Polyolefins have proven highly acceptable for such applications.

The closure and disc do not require a flexible construction and are also conveniently molded from polyolefins although other more rigid resins may also be employed.

The three components are easily fabricated and assembled. Preferably, the disc and closure may be assembled and then threaded onto the container. The container can be filled through the neck, or, in the instance of tubes, they can be filled and then the opposite end is closed and sealed.

In use, the child (or adult) can rotate the disc to align the discharge opening of the desired configuration in the operational position. Squeezing the container will then force material to flow from the interior of the container through the neck into the aperture and then outwardly through a discharge opening. The discharging material has the shape or configuration of the discharge opening selected and continuous beads or small deposits can be generated. When the squeezing pressure on the container is released, flow from the container ends. The material in the closure passages can be “sealed” by rotating the disc to a position in which the discharge apertures are not aligned with the discharge passage in the top wall.

Thus, it can be seen from the foregoing detailed description and the attached drawings that the present invention provides a novel squeezable container for a viscous product which can be discharged through a dispensing closure which provides a multiplicity of discharge openings of different cross sections. The container permits facile switching among the several discharge openings and it may be readily assembled from easily fabricated components.

Having thus described the invention, what is claimed is:

1. A dispenser for dispensing a viscous material in a selected one of a multiplicity of configurations comprising:
(a) a container for a volume of a viscous material and having a squeezable body and a neck with a discharge opening at its upper end;
(b) a closure body of generally circular cross section having a top wall and a skirt, said top wall having a discharge passage therethrough aligned with said discharge opening of said neck, said closure body having means thereon engaging said container, said top wall having a generally circular recess therein extending from the periphery thereof and beyond said discharge passage of said closure body;
(c) a generally circular disc disposed in said circular recess and having a discharge multiplicity of flow openings spaced thereabout in a circular array, said discharge openings having a multiplicity of configurations, said disc being rotatable in said recess to align a selected discharge opening with said discharge passage in said closure top wall to permit viscous material to flow through said neck and top wall of said closure into and through a selected disc discharge opening; and
(d) means rotatably mounting said disc on said closure body.

2. The dispenser in accordance with claim 1 wherein said container neck is externally threaded and wherein the bottom surface said closure body top wall has a depending threaded barrel threadably engaged on said neck.

3. The dispenser in accordance with claim 1 wherein said container is a flexible tubular member sealed at the end opposite said neck.

4. The dispenser in accordance with claim 1 wherein said closure includes an overcap having a top wall and a peripheral skirt.

5. The dispenser in accordance with claim 4 wherein the lower surface of said top wall of said overcap includes a circular boss concentric therewith and bearing on said disc.

6. The dispenser in accordance with claim 1 wherein said means for rotatably mounting said disc comprises an aperture in said closure body top wall and a mounting post on said disc which snaps into said aperture.
